(19) United States
(12) Patent Application Publication
(10) Pub. No.: US 2005/0150394 A1
(43) Pub. Date: Jul. 14, 2005

(54) Food embossing and impressing device

(76) Inventor: Richard Ben Errera, Ronkonkoma, NY (US)

Correspondence Address: ALFRED M. WALKER, 225 OLD COUNTRY ROAD, MELVILLE, NY, 11747-2712, US

(21) Appl. No.: 11/068,275

(22) Filed: Feb. 28, 2005

Related U.S. Application Data
(63) Continuation-in-part of application No. 10/423,562, filed on Apr. 25, 2003.
(63) Continuation-in-part of application No. 10/404,376, filed on Apr. 1, 2003.
(63) Continuation-in-part of application No. 10/634,438, filed on Aug. 5, 2003.
(63) Continuation-in-part of application No. 10/634,439, filed on Aug. 5, 2003.
(60) Provisional application No. 60/406,448, filed on Aug. 28, 2002.

(51) Int. Cl. A23L 1/00

(52) U.S. Cl. 99/388

(57) ABSTRACT

A device for impressing and embossing food items for both commercial and home use wherein the impressed and embossed images are interchangeable, allowing the user to form a pattern as desired.

### RELATED APPLICATIONS

This application is a continuation-in-part of the applications entitled Food Embossing Roller Device, the specification of which was filed on Apr. 25, 2003 as application Ser. No. 10/423,562; and application entitled Food Embossing Stamper Device, the specification of which was filed on Apr. 1, 2003 as application Ser. No. 10/404,376; and application entitled Enhanced Food Embossing Roller Device, the specification of which was filed on Aug. 5, 2003 as application Ser. No. 10/634,438; and application entitled Enhanced Food Embossing Stamper Device, the specification of which was filed on Aug. 5, 2003 as application Ser. No. 10/634,439. This application also claims benefit under 35 USC 119(e) for provisional application 60/406,448 of Aug. 28, 2002.

### FIELD OF THE INVENTION

The present disclosure relates to a device which forms raised/embossed or impressed forms in the surface of foods, such as a pizzeria name or logo.

### BACKGROUND OF THE INVENTION

Commercial and home cooks often decorate food surfaces for formal dinners, birthdays and special occasions. Foods may be decorated with edible flowers, icing, coloring tubes for writing of a sugar based paste, and/or edible wafers having images of photographs.

A number of known devices are designed to form a pattern, design or silhouette in food while the device also cooks the food, such as, for example, U.S. Pat. No. 5,996,476 to Schultz; U.S. Pat. No. 5,642,659 to Seasona et al., and U.S. Pat. No. 5,789,009, invented by Kordic et al. The patent to Mosby et al., U.S. Pat. No. 4,656,927, describes a device for producing designs on a slice of bread during toasting by shielding the bread in the shape of the design from the heat and thereby forming an image on the surface of the bread. Fiorenza, U.S. Pat. No. 4,290,349, discloses a toaster accessory which is dimensioned to fit a pre-made sandwich into a conventional toaster and optionally form decorative designs with inserts panels.

Other devices produce edible decorations which may be placed on food surfaces as desired, see, for example, U.S. Pat. No. 6,242,026 to Feeley. Alternatively, U.S. Pat. No. 4,578,273 to Krubert discloses a method of forming a hard, non-porous icing surface by drying an icing mixture and printing one or more edible inks on the icing using a printing pad having an edible silicone oil. The Quinlivan U.S. Pat. No. 4,285,978, discloses a method of transferring decorative designs onto baked goods by transferring a pre-printed design from a transfer material to an uncooked dough surface. Macpherson et al., in U.S. Pat. No. 5,017,394, describe a method of using a silk screen to form thin, flat, flexible, free standing base shapes or transfers directly on release paper to produce the final edible image for decorating foodstuffs. Ahn, U.S. Pat. No. 5,834,047, discloses a method of imprinting shapes of multiple colors inside confectionery products with edible ink.

U.S. Pat. No. 5,992,305, to Naivar describes a device that forms char marks to mimic a grill pattern on the surface of foods.

Older devices are known which may shape and cut dough foods such as, for example, an elongate rolling pin designed to roll and cut dough into long strips, a rolling pin designed to cut dough into shapes rather than using individual cookie cutters, and a rolling pin designed to form ravioli by pinching two layers of dough together at preset intervals after filing had been placed between the layers. See, U.S. Pat. No. 522,465 to Goodnough; U.S. Pat. No. 2,099,286 to Usbeck; and U.S. Pat. No. 2,075,157 to Alberti, respectively. Additionally, a U.S. patent to Blaul, U.S. Pat. No. 177,319, discloses a rolling pin having a permanently affixed intaglio, or engraved/carved, pattern to form shapes in the dough.

Also known is a dual rolling pin device having two rolling pins in the same plane and container means located above the rolling pins to emit flour over the surface of the rolling pins to prevent dough from sticking to the pins while in use. See, U.S. Pat No. 4,426,200 to Miller.

Frequently, writing is desired on various foodstuffs where the use of icing or a sugar base paste is undesirable. Therefore, an alternative device would be useful for marking foods on special occasions or, for example, re-enforcing the name of a pizzeria or bakery on pizza or breadsticks. Therefore, it would be advantageous to provide a device to mark foods.

### SUMMARY

This disclosure relates to a device for impressing and embossing food surfaces having interchangeable images. The device includes a housing, a carrier for image-producing letter blocks, message bands and message strips that are removeably attached to the housing, a letter block removeably attached to the carrier, a message band removeably attached to the carrier and a message strip that is removeably attached to the carrier. The interchangeable images are selected from the group consisting essentially of letters, numbers, words, pictures and punctuation marks.

In one embodiment, a decorating wheel for impressing and embossing images on food surfaces includes a semi-circular housing; a circular decorating wheel removeably attached to the housing; letter blocks removeably attached to the decorating wheel, a message strip removeably attached to the decorating wheel; and a message band removeably attached to the decorating wheel.

In one embodiment, a decorating stamper for impressing and embossing images on food surfaces includes a generally rectangular housing; a handle portion attached to an upper surface of the housing; a depth adjuster knob attached to an upper portion of the handle portion; an engaging column attached to a lower portion of the housing; a spring attached to the engaging column; a message plate attached to the lower portion of the housing; and a message strip removeably attached to the message plate.

In one embodiment, a device for impressing and embossing images onto a food product includes a decorating wheel having at least one food contact surface extending therefrom. The decorating wheel is rotatably movable about an axle, within a housing with a right housing half and a left housing half forming the housing. An attachment mechanism for quickly and removeably attaching the decorating wheel to the housing, and a hole for attachment of optional coloring modules, the housing being shell-shaped; the housing being self-standing on a work surface by resting on a forward edge of the housing; the decorating wheel being removeably attached to the housing: the decorating wheel rotating about an approximately central axis located through the cross-sectional plane of the decorating wheel.

In one embodiment, a device for impressing and embossing images upon food products includes a stamper pad enclosed within a vertically movable housing, the vertically movable housing having a handle extending therefrom; a depth adjuster knob, and a base ring covering and protecting a lower portion of the housing, wherein by temporarily removing the base ring, an exposed lower portion of the housing frames and cuts through a food work surface around an impressed and/or embossed image. The stamper pad includes a message plate, the message plate accepting removeably attaching an at least one of an image and block a message strips or a pre-formed message on an interchangeable message plate; the stamper pad having an engaging column, a spring, a housing, a handle and the depth adjuster knob; the message plate being pressed into contact with the food contact surface to form the image.

### DESCRIPTION OF THE DRAWINGS

The present disclosure can best be understood in connection with the accompanying drawings. It is noted that the invention is not limited to the precise embodiments shown in drawings, in which:

FIG. 1. A perspective view of a decorating wheel embodiment of the device.

FIG. 2. A perspective, exploded view of a decorating wheel embodiment of the device.

FIG. 3. A perspective view of the decorating wheel embodiment depicted potential attachment locations for letter blocks, message strip and message bands.

FIG. 4. A perspective view of a reversible impressing/embossing block for letters, number or other images.

FIG. 5. A perspective view of a reversible impressing/embossing block having edges curved upward or above the plane of the image-forming block.

FIG. 6. A perspective view of a reversible impressing/embossing block with edges curved downward from or angled away from the plane of the image-forming block.

FIG. 7. A side view detail of a letter block engaged with decorating wheel.

FIG. 8. A top view of flexible message strip.

FIG. 9. A side edge view of flexible message strip of FIG. 8.

FIG. 10. The perspective view, in detail, of elastomeric band with compatible letter blocks of an alternate embodiment.

FIG. 11. A perspective view of dual-sided elastomeric message band.

FIG. 12. A side schematic view showing location of optional color/oil rollers.

FIG. 13. A detailed view of an embossed message on dough in three different colors.

FIG. 14. A perspective view of the decorating stamper embodiment of the device.

FIG. 15. A perspective, exploded view of the decorating stamper embodiment of the device.

FIG. 16. A bottom view of impression/embossing plate with message.

FIG. 17. An impression/embossing plate accepting rectangular strips compatible with letter blocks of FIGS. 4-6.

FIG. 18. A side schematic view of alternate decorating stamper embodiment of the device with built-in fluid pad-upper position.

FIG. 19. A side view schematic during inversion of message plate.

FIG. 20. A side view schematic with message plate down.

### DESCRIPTION

This disclosure relates to a device that forms raised, i.e. embossed, and/or impressed words, letters, messages, designs, and images safely into foods, including fruits and doughs, as decoration and/or advertising. The device is hand-held and useful in both commercial and home settings for providing words, messages, phrases, in combination with images if desired, to any malleable food surface. The device may be embodied in a convenient decorating wheel shape to etch or form messages into circular food surfaces, such as piecrust or pizza crust. The decorating wheel format quickly and easily forms a contiguous message around a circumferential food surface, unlike a wider device, such as a rolling pin, which has an elongate shape and could not be rolled to easily follow a circumferential edge without impinging on a larger area of the food surface, and perhaps misshaping the rest of the food surface. The device may also be embodied in a hand-held decorating stamper form. These messages may be used, for example, as advertisement on pizza, rolls and/or other foods to denote the merchant. Additionally, the messages could be added for use on specific occasions, such as a birthday, a name day, a celebrated holiday or a party. The device can form words and messages to suit, according to the business and/or occasion at hand, as well as spell out names, dates and forms images such as faces, hearts, sun and moon, other patterns, and the like. The words and messages can be spelled in any language with or without images and/or dates interspersed in the words of the message with interchangeable dies having contact surfaces that form raised or impressed letters, words or images. For example, a restaurant may impress or raise/emboss words such as “Pizza Italia” around the crust of all pizzas sold, a bakery may impress or raise/emboss words such as “Broadway Bakery” or “Best Breads”, or a caterer may impress or raise words such as a bride and grooms names or the date of a wedding, the name of a company or organization holding a function, or the name of a fund raising event in fruits, bread, pastries or other foods. The words, messages and images may be customized as desired with interchangeable letters, numbers, and images. Pre-set messages and words may also be used in conjunction with the device to form frequently used sayings such as “Happy Birthday” or “Happy Anniversary”. Any desired message may be enhanced with the use of a coloring cartridge, which may be filled with any edible substance that will color the raised or impressed letters. For the purposes of this application, the term “image” is defined as including letters, words, numbers, symbols, and the like.

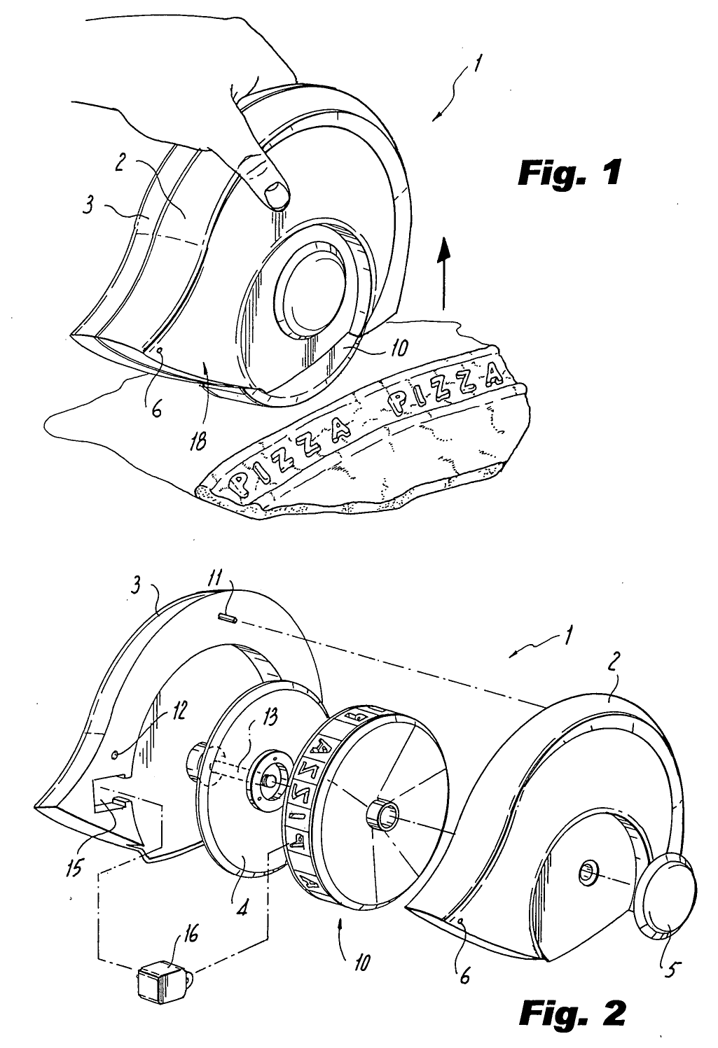

Referring to FIG. 1, there is shown a perspective view of the device in a roller embodiment, which includes a right housing half 2 and a left housing half 3 forming a housing 18, an attachment mechanism 5 for quickly and removeably attaching a decorating wheel 10, which acts as a carrier for image-producing letter blocks, message band and message strips, to the housing, and hole 6 for attachment of optional coloring modules. The housing 18 is generally semi-circular in silhouette, or “shell-shaped”, and can include grooves, which lie approximately parallel to the cross-sectional plane of the decorating wheel 10. The grooves of the housing 18 can be formed for ergonomic comfort of the user. The housing 18 can be formed to be self-standing on a work surface by resting on a forward edge of the housing. The decorating wheel 10 is removeably attached to the housing 18 and can be clipped on, screwed on, snapped on, or the like, to allow the decorating wheel 10 to rotate about an approximately central axis located through the cross-sectional plane of the decorating wheel 10.

Referring to FIG. 2, an exploded view of the housing 18 having a decorating wheel 10 and axle 13 with locking groove near distal end rigidly attached to a left housing half 3. A coloring cartridge module 16 consisting of a reservoir for a coloring substance and an application wheel is shown. The coloring cartridge module 16 functions as a reservoir for edible food coloring substances such as food dye, olive oil, colored sugars and the like. The food coloring substances can be released from the coloring cartridge module 16 and is spread on the decorating wheel 10 by a wheel, small brush, felt or other washable material which can wipe the food coloring substances onto the decorating wheel 10 as it rotates passed the coloring cartridge module 16. The coloring cartridge module 16 correlates with cavity 15 in the left housing half 3 for securely holding the coloring cartridge module 16 in its desired location where the wheel portion of the coloring cartridge module 22 can contact the periphery of the food contact surface of the decorating wheel 10.

The alignment hole 12 and the alignment peg 11 each function to securely hold the housing halves together by correlating with a mirror-image feature located on the right housing half 2 during assembly, i.e. a peg (not shown) inserts into alignment hole 12 and a hole (not shown) to accept the insertion of alignment peg 11. An optional cutting blade 4 is shown for trimming food stuffs as it is impressed and/or embossed, and is removeably attached to the housing 18. An optional non-sharpened guide wheel (not shown) having blunt edges and approximately the same size as the optional cutting blade 4, can be removeably attached to the housing 18 and used to adjust the depth of the impressing/embossing of the decorating wheel 10. The guide wheel can also assist in aligning the desired image with an edge or line in the food surface.

In one embodiment, the interchangeable decorating wheel 10 may have different diameters to easily accommodate varying dimensions of food work surfaces. For example, it may be desirable to employ a decorating wheel 10 with a comparatively small diameter on a pastry, for example, as compared to a decorating wheel 10 which may be used to impress or raise letter or images on a pizza or calzone crust. The size of the housing 18 may be formed to accommodate rollers of different diameters, such that smaller and larger diameter rollers can effectively rotate while removeably attached to the housing 18.

In another embodiment, rollers of varying diameters may be removeably attached to the housing 18 with snap-on, clip-on, screw-on or other means along different optional locations in the housing 18 to allow effective rotate and function of small diameter rollers, with respect to the size of the housing 18. In such an embodiment, the housing 18 may include a plurality of decorating wheel attachment cites which can accommodate varying decorating wheel diameters.

In an alternative embodiment, two narrow rollers 10 may be removeably attached to the housing 18 for concurrent use on a food surface to impress and/or emboss the same or different messages in a somewhat parallel format.

Referring to FIG. 3, the decorating wheel 10 is shown having a flange 20 and having an attaching rim 22 where the letter blocks 27 and the rim 22 are orientated towards the food work surface. The flange 20 is generally circular and meets the rim 22 in a generally perpendicular fashion along the circumference of the flange 20. The flange 20 provides a mechanical connection between an axle bearing and spacer 21. The flange 20 has a series of regularly positioned rectangular slots 23 at the junction of rim 22 into which a block 27 may snap or slide to form any desired message or image to be impressed and/or embossed/raised into a food surface. The rim 22 also includes a number of regularly spaced holes to accept a message strip or message band and prevent slipping of the strip or band while in use.

The flange 20 may include a plurality of slots 23 to allow the insertion of a plurality of blocks 27 as desired, to spell out any word or message that may be required and/or images, as desired. The blocks 27 may be formed of varying widths, with respect to the width of the decorating wheel 10, and can align with the pre-determined location of the slots 23. The interchangeable, multi-use, and re-arrangeable nature of the blocks 27 allow an infinite number of different messages or combinations of words to be impressed and/or raised/embossed in to a food surface as an occasion demands, and may then be changed for the following occasion.

The block 27 may be formed to impress a letter, numbers, words, pictures, punctuation marks, or image (hereinafter referred to collectively as “letters”) into a food surface, or the block 27 may be formed to produce raised/embossed letters, numbers or images, i.e. the block may form embossments on food surfaces. The blocks 27 may be formed of any sturdy materials for use with foods, such as, for example, plastics which can be molded or cast into shapes, metals such as copper, aluminum, and steel, and hard woods. The images may also be fixedly attached to the surface of a letter block. The impressing and embossing portion of the block 27 may include an angle draft of 0.5% to 10%, typically 2% to 4%, in difference between the upper and lower walls of the that impressing or embossing portion. The blocks 27 may be formed to be doubled sided, having the same letter in both sides or surface of the block, the same letter in upper and lower case, having frequently used letters and additional vowels on one side to easily customize any word or message, and/or the same letter, number or image having impressing forms on one side and raised/embossing forms on the opposite side. In an alternative embodiment, the block may have an image on one side or surface of the block and the image may be impressing or embossing.

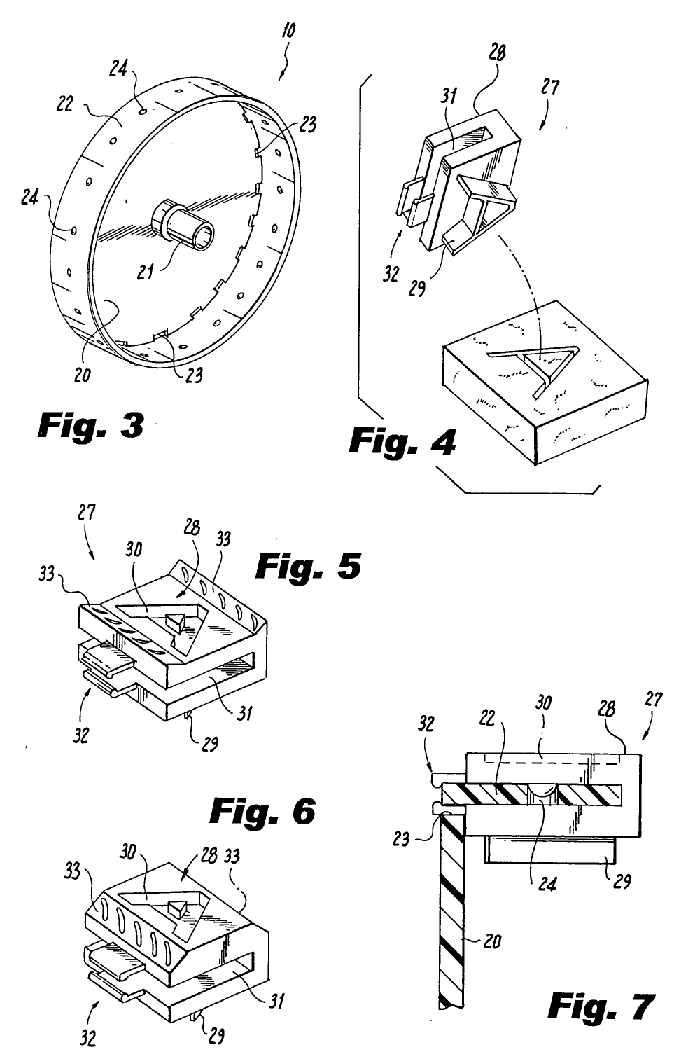

Referring to FIG. 4, a letter block or block 27 includes a slot 31, latch extensions 32, a flat food contact surface 28 with the edge 33 which may include optional side impressing or raising/embossing decoration, a letter impression 29, and same letter carved out below the contact surface to form a raised or embossed form 30 on the opposite surface. The latch extensions 32 snaps into the rectangular slots 23 of the rim 22 while the rim 22 slides into the slot 31 for added stability during use. Once the desired letter block 27 are chosen and mounted on the rim 22, it can be moved over a food surface to spell/form any message. The resulting pattern of the food surface is dependant on whether the impressing 29 or embossing 30 side of the block 27 is positioned to face and interact with the food surface. The block 27, as shown in its impressing form in FIG. 4, includes a form of the particular letter that can be forced or pushed into the food surface and leave an impression of that letter in the food. The form of the letter on the impressing block 27 is raised above the food contact surface of the decorating wheel 10 or above the surface of a band 51 (as shown in FIG. 10), if such is used, approximately ¼ of an inch or more, although a slightly less raised letter form would also be legible, to impress a sufficiently deep letter form and allow the letter to be legible. The decorating wheel 10 is pushed along the food work surface to allow each letter block 27, in turn, to come in contact with the food surface and form or spell the desired message or image and the message may be repeated as desired.

To form raised letters or images, the block 27 includes the form of the letter, numbers, words, pictures, punctuation marks, or image cut or carved into the block's 27 initially, substantially flat food contact surface below the surface of the block 27 material. The block 27 material can be carved to a depth sufficient to force the foodstuff of the food work surface up into the carved out form of a letter or image while applying the decorating wheel to the food work surface. The block 27 material may be carved out to a depth of approximately ¼ of an inch or more to allow sufficient dough to be forced upward into a raised pattern and substantially hold that pattern after cooking or baking, although a slightly more shallow depth will form a pattern as well.

The food contact surface of the block 27 that forms raised letters includes an uncut portion surrounding the carved out portion. These uncut portions of the block 27 food contact surface can form the edges around the carved out portion and can provide contact force to the food surface. The edges may be formed in a width approximately in the range of as wide as the carved out portion, in toto, to as wide as the carved out portion of the block 27 on each side of the carved out pattern. These edges help force the food dough into the cutout and smooth out the surrounding area to give the letter or other image, a noticeable raised, relief pattern.

The edges of the block 27 food contacts surface surrounding the carved out portion may be slightly ridged with respect to the depth of the carved out portion. The ridges can assist to spread out the food surface evenly without leaving ridge mark that noticeably remain after the cooking/baking process. When used with other foods, such as fruits, the consistency of the individual fruit can determine whether ridge marks might be more noticeable. In another embodiment, the edges may be mostly slightly ridged or flat, and include a deliberate pattern along the outer most portion of the edge of the block 27. Such patterns may include, for example, a scroll, a floral chain, a wave pattern, and the like.

As shown in FIG. 5, raised or embossed letter block 27 may be formed in an alternative pattern to assist in the movement of dough or food in to the letter form 29. The edges of the food contact surface 28 of the block 27 may be curved upward, or above, the food contact surface of the block 27 with respect to the block area surrounding the image. Such curved upward edges 33 can assist in pushing dough or other food stuffs into the carved out portion of the block 27, as well as forming an ornamental design along the edges where desired. This block 27 having curved upward edges 33 attaches to the decorating wheel 10 by sliding the slot 31 over the rim 22 to allow the latch extensions 32 to latch onto the rectangular slots 23 of the rim 22. The block 27 can then be used in conjunction with the decorating wheel 10 to form any message. Note that the block 27 is doubled sided and includes an impressing letter 30 on an opposite side.

Referring to FIG. 6, a block 27 is depicted having a alternative whereby surface 28 is above edges 33 which slope or curve downward with respect to the area of the block contact surface surrounding the image. A block 27 which forms raised or embossed letters may include the edges 33 of block 27 food contact surface 28 which are curved away from, or curved downward with respect to the food contact surface of the block. The curved away edges can assist in forcing dough or other food stuff into the carved out portion of the block 27 and smoothing out the surrounding food surface. The edges 33 may also be used to form a pattern which outlines the letters formed. Note that the block 27 is doubled sided and includes an impressing letter 30 on an opposite side.

Referring to FIG. 7, depicted is the letter block 27 in cross-section as it is snapped through a rectangular hole 23 in rim 22 of decorating wheel 10 for use as an impressing/embossing tool. The rim 22 is shown as located inside the slot 31 of the block 27. The nibs on the distal ends of latch extensions 32 snap over the edge of rim 22 at the top and through the edge of rectangular hole 23 at the bottom respectively. In this way, letters can be easily snapped onto, or off, decorating wheel 10 to form a message. This cross-sectional view of the block 27 shows the impressing side 30 of the block 27 and the embossing side 29.

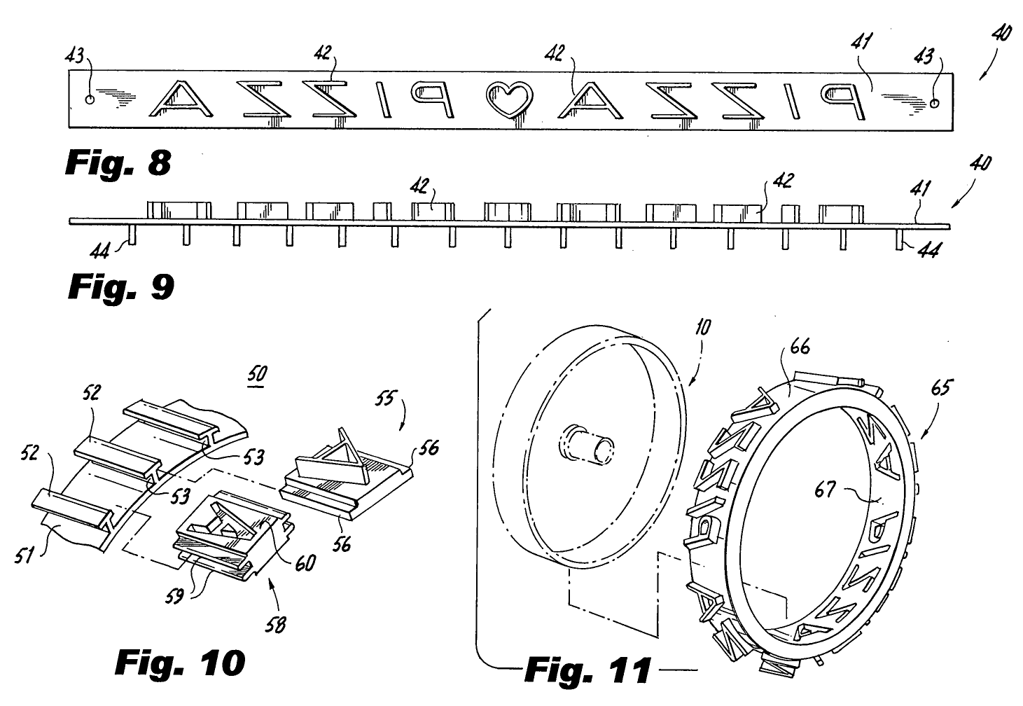

FIG. 8 depicts a top view of a cast or molded flexible message strip 40 having attachment end-hole 43 to allow the message strip 40 to be attached to either embodiment of the device, i.e. a decorating wheel 10 or a decorating stamper 80(see, FIG. 17). The flexible message strip 40 includes a pre-formed message for convenient use and impressing words down into the food surface or forming raised/embossed words above the general food contact surface. The flexible message strip includes nibs 44, located on the lower surface of the flexible messages strip (not shown), are spaced so as to fit holes 24 on rim 22 of wheel 10. A spring clip retains the flexible message strip 40 through holes 43, and holes 24 of the decorating wheel 10 retain the flexible message strip 40 while it is in use. The flexible message strip 40 is removable and interchangeable with other message strips.

Referring to FIG. 9, a side view of the flexible message strip 40 is show having cast or molded, permanent message affixed thereon. The flexible message strip includes nibs 44, located on the lower surface of the flexible messages strip, shown in a side-view, are spaced so as to fit holes 24 on rim 22 of wheel 10. A spring clip retains the flexible message strip 40 through holes 43, and holes 24 of the decorating wheel 10 retain the flexible message strip 40 while it is in use. The flexible message strip 40 is removable and interchangeable with other message strips having additional messages.

Referring to FIG. 10, depicts a flexible elastomeric band that fits snugly over the rim 22 of the decorating wheel 10 and includes transverse ribs 52 formed in a “T”-shape having undercut channels 53 on the surface of the decorating wheel 10. The undercut channels 53 allow the blocks to slide therebetween via block flanges 59 of a double-sided letter block 58 or via a single block flange 56 of a single sided letter block 55. The band 51 has a set of equally spaced transverse ribs 52 with undercut channels 53. The transverse ribs 52 form pockets for receiving either letter blocks 55 or 58. One-sided block 55 has an embossing or impressing format on only the top surface, and flanges 56 fit into channels 53. The double sided blocks 58 have an impressing side 60 on one side and an embossing side on the opposite surface. A slot 61 accommodates rim 22 as well as the thickness of band 51. The top pair of flanges 59 of block 58 can engage channels 53. In this manner, letter block 58 are easily attached and interchanged on to the band 51, to produce messages and images for any occasion on the surface of a food. Alternatively, in yet another embodiment, a decorating wheel having transverse ribs 52 may be used, rather than a band 51, to attach the letter block 55 or 58 to form images in food surfaces.

Referring to FIG. 11, an alternative message embodiment is depicted as a double sided, or single sided, elastomeric band 65. The band 65 is tightly stretched or slid over rim 22 of decorating wheel 10 and remains in place during use. A pre-formed message is molded or cast on one side to impress a message 66 into a food surface and, when the band 65 is inverted to expose the opposite side and message, a message can be formed which may include the same words in a different form, i.e. embossing rather than impressing, than the opposite band side or an entirely new message may be present. In an alternative embodiment, the band 65 may form embossing images on the food surface. A band 65 has pre-set, frequently-used words or messages permanently formed on the band for convenient and can easily slide on to a decorating wheel 10 as needed without individually attaching each block 27. The bands 65 may be formed of a food compatible, flexible material or combination of materials, such as, for example, plastics, silicone, rubbers, elastomers and the like.

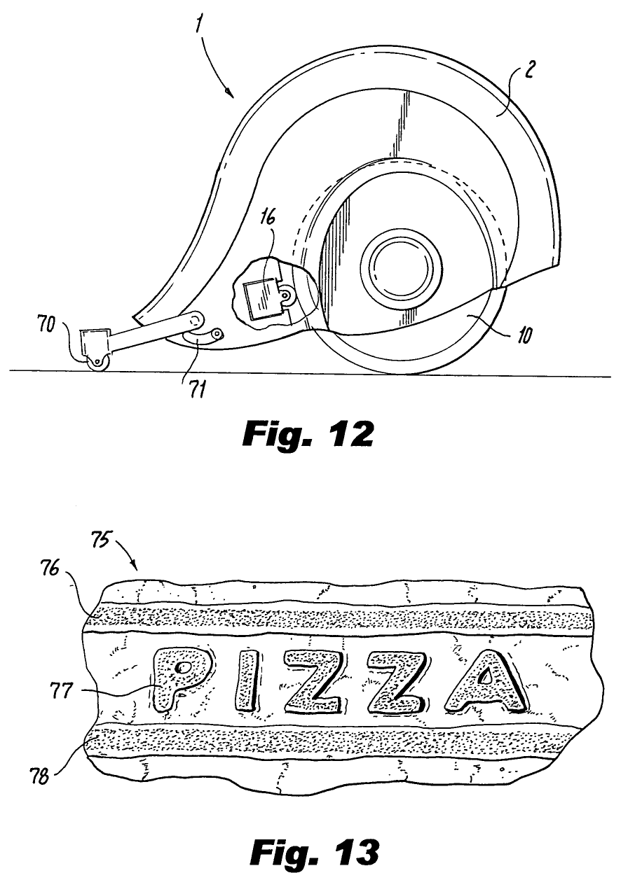

Referring to FIG. 12, a side schematic view of FIG. 12 shows two possible positions for coloring substances and/or oil transferring rollers with reservoirs or coloring cartridge module with respect to the housing 18. A single-wide wheel 16, which is capable of transferring color substances that are acceptable for use with foods, deposits an area of coloring substance onto the decorating wheel 10. The coloring substance is deposited on the decorating wheel 10 and any block 27, message strips 40, or band 65 located on the decorating wheel 10. The coloring substance is then transferred onto the food surface as the decorating wheel 10 is moved over the food surface to impress or emboss images. Where two narrow wheels 16 with a space between are used in position 16 with separate reservoirs, two stripes of different colors can be applied on either side of a message. A third, narrow wheel 70 can be cantilevered from housing 18 and used on an/impressed/embossed message to add further coloring substances. A third wheel 70 can be adjusted in height via an adjuster 71 to color enhance only the highest raised portions of embossed letters or the food surface surrounding impressed letters. As shown in FIG. 13, a tricolored decoration can be made in this manner by using three different wheels. The two stripes 76 and 78, upper and lower, respectively, can be deposited by narrow dual wheels 16, and followed by decorating wheel 70 which can color the message in a third color, if desired. The coloring wheels can enhance the food work surface for a finished surface having a rainbow or stripe effect in any combination. This coloring effect may be used to enhance an impressed or embossed message according to the holiday or occasion at hand, making the food more appealing to its audience and more unique for a food merchant's sales.

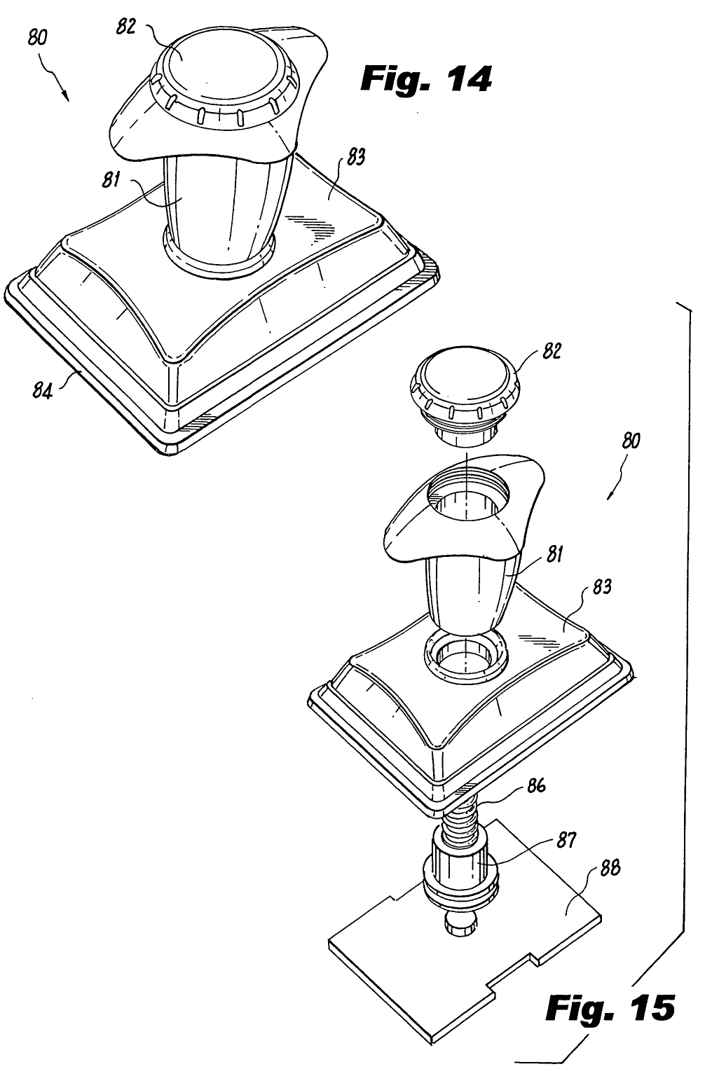

In FIG. 14 is shown yet another embodiment of the food impressing/embossing device which can impress messages, words and images into or onto a food surface, as desired by the user, by employing the interchangeable letter blocks 27 and/or message strips 40. The depicted decorating stamper embodiment 80, is formed of a durable material and acts as a carrier for image-producing letter blocks, message band and message strips, includes a handle 81 for ergonomic ease of use, depth adjuster knob 82 to accommodate the many different types and consistency of food surfaces to be impressed or embossed, a housing 83 for lightweight, easy handling by the user and a base ring 84 which covers and protects the lower portion of the housing 83. By temporarily removing the base ring 84, the exposed lower portion of the housing 83 can frame and cut through the food work surface around any impressed or embossed message or image.

Referring to FIG. 15, an exploded view showing the decorating stamper embodiment of the device, depicting the typical components of the decorating stamper embodiment. The decorating stamper includes a generally rectangular housing 83 having at least an upper and lower surface; a handle portion 81 attached to an upper surface of the housing; a depth adjuster knob 82 attached to an upper portion of the handle portion 81; an engaging column 87 attached to a lower portion of the housing 83; a spring 86 attached to the engaging column 87; and a message plate 88 attached to the lower portion of the housing 83 via the engaging column 87. The message plate 88, which can accept and removeably attach blocks 27 and message strips 40 or may have a pre-formed message molded or cast on an interchangeable message plates 88. The message plate 88 is pressed into contact with the food contact surface to form the desired message and may be repeatedly brought into contact with the food surface to a multitude of possible patterns.

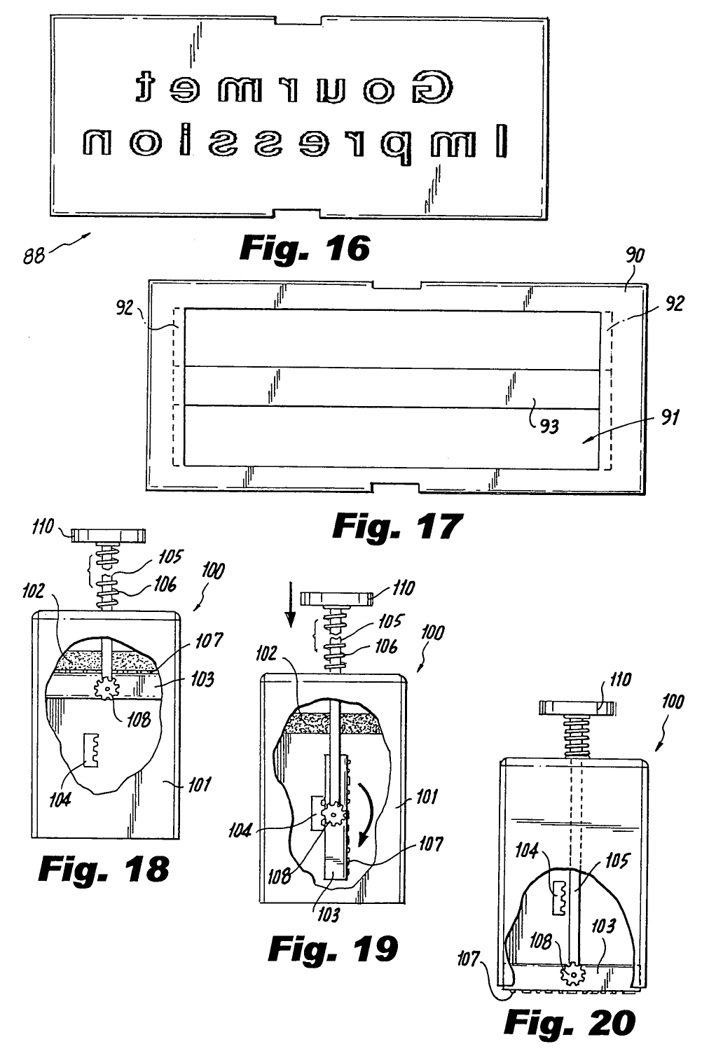

FIG. 16 depicts a view of a cast message plate 88 having a pre-formed message which might be frequently or commonly used to form either impressed or embossed messages into a food surface. Such a message plate 88 is readily interchangeable and other message plates include those that accept blocks 27 and message strips 40 to provide an infinite variety of message available for any commercial and home-use requirements. A decorating stamper embodiment may be combined with blocks 27, message plates 88 and flexible message strips 40 to form a kit. Alternatively, a kit may be combined having a decorating wheel 10 along with blocks 27, message plates 88, flexible message strips 40 and any bands 51, and/or 65 to form a kit, with or without a decorating stamper embodiment of the device. Coloring substances can be added to message plate 88 by using a brush or by using a stamping pad similar having edible coloring substances.

Referring to FIG. 17, an alternate embodiment of a message plate 90 is shown. Message plate 90 has a recessed central area 91 and having channels 92 at each shorter-leg of the rectangular message plate 90. The distal ends of spring-like strips 93 (only one is shown for clarity) are attached to the message decorating stamper 90 within the recessed central area 91 via the channels 92. Strips 93 have the same cross-section shape and size as rim 22 of decorating wheel 10 (as shown in FIG. 7). Therefore letter blocks of a letter block kit (portions as shown in FIGS. 4-6) can be assembled over strips 93. Once the desired message is assembled on one or more strips 93, the strips 93 are inserted in recessed central area 91 via channels 92 and messages strips 40 may be similarly inserted into the channels 92. The decorating stamper can then be used on any food surface to customize or decorate the surface for any celebration or occasion. Coloring substances can be added to message plate 88 by using a brush or by using a stamping pad having edible coloring substances.

An alternate embodiment of the decorating stamper embodiment is shown in FIGS. 18,19 and 20, which depict the functioning of a self-coloring food decorating stamper as configured with an integral food color pad. A rack and pinion mechanism is shown in the schematic sequence of FIGS. 18-20, although any of the mechanisms, suitably enlarged, of self-inking stamping devices can be used as well, such as, for example, those disclosed in U.S. Pat. Nos. 2,312,727 and 4,432,281, which are incorporated herein in their entity.

FIG. 18 depicts a side view schematic of self-coloring decorating stamper 100 in its resting position. A self-coloring decorating stamper includes a housing 101 of durable material; a short gear rack 104 rigidly attached to the housing 101 and a coloring substance pad 102 removeably attached to the housing. A message surface 107 is rotatablely in contact with the coloring substance pad 102. The spring 106 is biasing the rod 105 in an upward direction. As force is applied to knob 110, the spring 106 is compressed and the rod 105 forces the plate 103 downward. As the force is further applied, the pinion gear 108 which is attached to the plate 103 engages the fixed gear rack 104 causing the plate 103 to turn over as shown in FIG. 19. Further movement downward rotates the message surface 107 facing down before disengagement with the rack 104. Further movement causes contact with food contact surface as shown in FIG. 20. By releasing knob 110, it will be understood that surface 107 can again be rotated upward prior to contacting pad 102.

In an alternative embodiment, the plate 88 of the stamper may have a curved or angled food contact surface to accommodate food of various geometric configurations, such as spheres, hemispheres, pyramids and the like.

It will be appreciated that the blocks of both single and double-sided forms provide an “open frame” or “open architecture”, multiple use choices for any desired pattern. A user may both impress and emboss any word, message or image into any foodstuff easily by changing the block to spell a word or phrase in any language. Such an open format is ideally suited for a kit, in which letter blocks formed to depict various languages and other images may be included with an applicator, such as a decorating wheel or decorating stamper embodiment.

In the foregoing description, certain terms and visual depictions are used to illustrate the preferred embodiment. However, no unnecessary limitations are to be construed by the terms used or illustrations depicted, beyond what is shown in the prior art, since the terms and illustrations are exemplary only, and are not meant to limit the scope of the present invention.

It is further known that other modifications may be made to the present invention, without departing the scope of the invention, as noted in the appended Claims.

1. A device for impressing and embossing food surfaces having interchangeable images comprising: a housing, a carrier for image-producing letter blocks, message bands and message strips that is removeably attached to the housing, a letter block removeably attached to the carrier, a message band removeably attached to the carrier and a message strip removeably attached to the carrier.

2. A device for impressing and embossing food surface of claim 1, wherein the interchangeable images are selected from the group consisting essentially of letters, numbers, words, pictures and punctuation marks.

3. A device for impressing and embossing food surface of claim 2, wherein the interchangeable images have an angle draft in the range of approximately 0.5% to approximately 10%.

4. A device for impressing and embossing food surface of claim 3, wherein the interchangeable images have an angle draft in the range of approximately 2% to approximately 4%.

5. A device for impressing and embossing food of claim 3, wherein the housing is formed of a durable material.

6. A device for impressing and embossing food of claim 5, wherein the a coloring cartridge is removeably attached to the housing.

7. A device for impressing and embossing food surface of claim 6, wherein the carrier is a decorating wheel.

8. A device for impressing and embossing food surface of claim 7, wherein the decorating wheel is removeably attached to housing.

9. A device for impressing and embossing food surface of claim 8, wherein the decorating wheel has a flange perpendicularly attached to a rim.

10. A device for impressing and embossing food surface of claim 9, wherein the decorating wheel has a plurality of rectangular slots.

11. A device for impressing and embossing food surface of claim 10, wherein a plurality of rectangular slots located where the flange is perpendicularly attached to the rim.

12. A device for impressing and embossing food surface of claim 11, wherein the decorating wheel has a plurality of holes in the rim.

13. A device for impressing and embossing food surface of claim 12, wherein the letter blocks are interchangeable.

14. A device for impressing and embossing food surface of claim 13, wherein the letter blocks snap into the rectangular slots.

15. A device for impressing and embossing food surface of claim 14, wherein the letter blocks snap into the rectangular slots via latch extensions.

16. A device for impressing and embossing food surface of claim 15, wherein the letter blocks are doubled-sided.

17. A device for impressing and embossing food surface of claim 15, wherein the letter blocks are single-sided.

18. A device for impressing and embossing food surface of claim 16 or 17, wherein the letter blocks form an impression into a food surface.

19. A device for impressing and embossing food surface of claim 18, wherein the impression is formed by a molded image.

20. A device for impressing and embossing food surface of claim 19, wherein a molded image is fixedly attached to a surface of the letter block.

21. A device for impressing and embossing food surface of claim 20, wherein the molded image rises above the surface of the letter block.

22. A device for impressing and embossing food surface of claim 16 or 17, wherein the letter blocks form an embossment on a food surface.

23. A device for impressing and embossing food surface of claim 22, wherein the letter blocks have carved-out forms below the surface of the letter block.

24. A device for impressing and embossing food surface of claim 23, wherein the letter block edges are ridged.

25. A device for impressing and embossing food surface of claim 23, wherein the letter blocks have edges curved upward from the surface of the block.

26. A device for impressing and embossing food surface of claim 23, wherein the letter blocks have edges curved downward from the surface of the block.

27. A device for impressing and embossing food surface of claim 23, wherein the letter blocks have decorative patterns on the edges of the blocks.

28. A device for impressing and embossing food surface of claim 12, wherein a message band snaps into a plurality of holes in the rim.

29. A device for impressing and embossing food surface of claim 28, wherein a message band has a molded impressing image.

30. A device for impressing and embossing food surface of claim 28, wherein a message band has a molded embossing image.

31. A device for impressing and embossing food surface of claim 29 or 30, wherein the message band is interchangeable.

32. A device for impressing and embossing food surface of claim 31, wherein the message band is double -sided.

33. A device for impressing and embossing food surface of claim 31, wherein the message band is single-sided.

34. A device for impressing and embossing food surface of claim 12, wherein a message strip snaps into a plurality of holes in the rim.

35. A device for impressing and embossing food surface of claim 34, wherein a message strip has a molded impressing image.

36. A device for impressing and embossing food surface of claim 34, wherein a message strip has a molded embossing image.

37. A device for impressing and embossing food surface of claim 35 or 36, wherein the message strip is interchangeable.

38. A device for impressing and embossing food surface of claim 37, wherein the message strip is double-sided.

39. A device for impressing and embossing food surface of claim 37, wherein the message strip is single-sided.

40. A device for impressing and embossing food surface of claim 6, wherein a carrier is a decorating stamper.

41. A device for impressing and embossing food surface of claim 40, wherein a message plate is removeably attached to the decorating stamper.

42. A device for impressing and embossing food surface of claim 41, wherein the message plate has a molded impressing image.

43. A device for impressing and embossing food surface of claim 41, wherein the message plate has a molded embossing image.

44. A device for impressing and embossing food surface of claim 41, wherein the message plate has channels.

45. A device for impressing and embossing food surface of claim 44, wherein pre-formed message strips slide into the channels.

46. A decorating wheel for impressing and embossing images on food surfaces comprising: a semi-circular housing; a circular decorating wheel removeably attached to the housing; letter blocks removeably attached to the decorating wheel, a message strip removeably attached to the decorating wheel; and a message band removeably attached to the decorating wheel.

47. A decorating wheel of claim 46, wherein the decorating wheel has a flange perpendicularly attached to a rim.

48. A decorating wheel of claim 47, wherein the decorating wheel has a plurality of rectangular slots.

49. A decorating wheel of claim 48, wherein a plurality of rectangular slots located where the flange is perpendicularly attached to the rim.

50. A decorating wheel of claim 49, wherein the decorating wheel has a plurality of holes in the rim.

51. A decorating wheel of claim 50, wherein letter blocks snap into the rectangular holes.

52. A decorating wheel of claim 51, wherein the letter blocks are interchangeable.

53. A decorating wheel of claim 52, wherein the letter blocks are doubled-sided.

54. A decorating wheel of claim 52, wherein the letter blocks are single-sided.

55. A decorating wheel of claim 53 or 54, wherein the letter blocks form an impression into a food surface.

56. A decorating wheel of claim 55, wherein the impression is formed by a molded image.

57. A decorating wheel of claim 56, wherein the molded image is fixedly attached to a surface of the letter block.

58. A decorating wheel of claim 57, wherein the molded image rises above the surface of the letter block.

59. A decorating wheel of claim 53 or 54, wherein the letter blocks form an embossment on a food surface.

60. A decorating wheel of claim 59, wherein the letter blocks have carved-out forms below the surface of the letter block.

61. A decorating wheel of claim 60, wherein the letter block edges are ridged.

62. A decorating wheel of claim 60, wherein the letter blocks have edges curved upward from the surface of the block.

63. A decorating wheel of claim 60, wherein the letter blocks have edges curved downward from the surface of the block.

64. A decorating wheel of claim 60, wherein the letter blocks have decorative patterns on the edges of the blocks.

65. A decorating wheel of claim 60, wherein the image is selected from the group consisting essentially of letters, numbers, words, pictures and punctuation marks.

66. A decorating wheel of claim 51, wherein a message band has a molded impressing image.

67. A decorating wheel of claim 51, wherein a message band has a molded embossing image.

68. A decorating wheel of claims 66 or 67, wherein the message band is interchangeable.

69. A decorating wheel of claim 68, wherein the message band is double -sided.

70. A decorating wheel of claim 68, wherein the message band is single-sided.

71. A decorating wheel of claims 69 or 70, wherein the message band snaps into the plurality of holes in the rim.

72. A decorating wheel of claim 71, wherein the message band has a molded image selected from the group essentially consisting of letters, numbers, words, pictures and punctuation marks.

73. A decorating wheel of claim 51, wherein a message strip has a molded impressing image.

74. A decorating wheel of claim 51, wherein a message strip has a molded embossing image.

75. A decorating wheel of claim 73 or 74, wherein the message strip is interchangeable.

76. A decorating wheel of claim 75, wherein the message strip is double -sided.

77. A decorating wheel of claim 75, wherein the message strip is single-sided.

78. A decorating wheel of claims 76 or 77, wherein the message strip has a molded image selected from the group consisting essentially of letters, numbers, words, pictures and punctuation marks.

79. A decorating wheel of claim 51, wherein a circular, blunt-edged guide wheel is removeably attached to the housing.

80. A decorating wheel of claim 51, wherein a circular cutting wheel is removeably attached to the housing.

81. A decorating stamper for impressing and embossing images on food surfaces comprising: a generally rectangular housing; a handle portion attached to an upper surface of the housing; a depth adjuster knob attached to an upper portion of the handle portion; an engaging column attached to a lower portion of the housing; a spring attached to the engaging column; a message plate attached to the lower portion of the housing; and a message strip removeably attached to the message plate.

82. A decorating stamper of claim 81, wherein the housing is formed of durable material.

83. A decorating stamper of claim 82, wherein a message plate has pre-formed impressing messages.

84. A decorating stamper of claim 82, wherein a message plate has pre-formed embossing messages.

85. A decorating stamper of claim 83 or 84, wherein a message plate has channels.

86. A decorating stamper of claim 85, wherein a message strip slides into the channels.

87. A decorating stamper of claim 86, wherein a message strip has a pre-formed impressing image.

88. A decorating stamper of claim 86, wherein a message strip has a pre-formed embossing image.

89. A self-coloring decorating stamper for impressing and embossing images on food surfaces comprising: a durable housing; a short gear rack rigidly attached to the housing; a coloring substance pad removeably attached to the housing; a message surface rotatablely in contact with the coloring substance pad; a spring biasing a rod attached to the message surface; a knob attached to the spring; a pinion gear attached to the message surface; and
the pinion gear engagingly attached to a gear rack.

90. A device for impressing and embossing images onto a food product comprising:
a decorating wheel having at least one food contact surface extending therefrom;
said decorating wheel rotatably movable about an axle, within a housing;
a right housing half and a left housing half forming said housing;
an attachment mechanism for quickly and removeably attaching said decorating wheel to said housing, and a hole for attachment of optional coloring modules.;
said housing being shell-shaped;
said housing being self-standing on a work surface by resting on a forward edge of said housing;
said decorating wheel being removeably attached to said housing;
said decorating wheel rotating about an approximately central axis located through the cross-sectional plane of said decorating wheel.

91. A device for impressing and embossing images onto a food product as in claim 90, wherein: said housing axle attached with a locking groove near a distal end thereof, said locking groove rigidly attached to one of said housing halves.

92. The device for impressing and embossing images onto a food product as in claim 90 further comprising: a coloring cartridge module including a reservoir dispensing a coloring substance therefrom to the food product, said coloring cartridge module retaining edible food coloring substances;
said food coloring substances being released from said coloring cartridge module and being spread on said decorating wheel by a wiper wiping said food coloring substances onto said decorating wheel as said decorating wheel rotates passed said coloring cartridge module;
said coloring cartridge module fitting with a cavity in one of said housing halves securely holding said coloring cartridge module in a predetermined location where said further wheel of said coloring cartridge module contacts a periphery of said at least one food contact surface of said decorating wheel.

93. The device for impressing and embossing images upon food products as in claim 90 further comprising:
an alignment hole and an alignment peg on one of said housing halves each securely holding said housing halves together by correlating with a mirror-image alignment hole and peg located on a respective opposite housing half.

94. The device for impressing and embossing images on food products as in claim 90 further comprising:
a cutting blade being provided for trimming the food product as the food product is impressed and/or embossed;
said cutting blade being removeably attached to said housing.

95. The device for impressing and embossing images on food products as in claim 94 further comprising: said device further having a non-sharpened guide wheel having blunt edges and being approximately the same size as said cutting blade, said guide wheel being removeably attached to said housing, said guide wheel adjusting a predetermined depth of the impressing/embossing of said decorating wheel; said guide wheel aligning a desired image with a predetermined location on the food surface.

96. The device for impressing and embossing images upon food products as in claim 90 further comprising: said decorating wheel being an interchangeable decorating wheel with other interchangeable decorating wheels; said interchangeable decorating wheel each having different diameters accommodating varying dimensions of food work surfaces; said housing being variable in width to accommodate decorating wheels of different diameters, wherein smaller and larger diameter decorating wheels can effectively rotate being removeably attached to said housing.

97. The device for impressing and embossing images on food products as in claim 96 wherein: said decorating wheels of varying diameters may be removeably attached to said housing along different optional locations in said housing to allow effective rotation of said decorating wheels, with respect to the size of said housing.

98. The device for impressing and embossing images upon food products as in claim 97 further comprising: said housing including a plurality of roller attachment locations accommodating varying diameters of said decorating wheels.

99. The device for impressing and embossing images upon food products as in claim 98 wherein: a plurality of narrow decorating wheels are removeably attached to said housing concurrently to impress and/or emboss a plurality of different images in a parallel format.

100. The device for impressing and embossing images upon food products as in claim 90 further comprising: said decorating wheel having a flange and having an attaching rim where a plurality of image blocks and said rim are orientated towards the food work surface; said flange being generally circular and meeting said rim in a generally perpendicular orientation along a circumference of said flange; said flange providing a mechanical connection between an axle bearing and spacer; said rim also has a series of holes into which are of said image block is inserted to form any desired message or image to be impressed and/or embossed/raised into the food surface.

101. The device for impressing and embossing images upon food products as in claim 100 wherein said decorating wheel accommodates a removable elastomeric band accommodating having impressing and/or embossing images thereon.

102. The device for impressing and embossing images upon food products as in claim 100 further comprising: said rim of said flange including a plurality of slots allowing insertion of said plurality of said image blocks imparting images therefrom; said image blocks being formed of varying widths, with respect to the width of said decorating wheel; said interchangeable, multi-use, and re-arrangeable nature of said image blocks allowing a plurality of images to be impressed and/or raised/embossed at the food surface as an occasion demands, and then changed for a subsequent occasion.

103. The device for impressing and embossing images upon food products as in claim 102 wherein said image blocks provide an image selected from the group consisting of at least one of raised embossed or impressing letter, number or image into the food surface.

104. The device for impressing and embossing images upon food products as in claim 103 wherein: an impressing and embossing portion of each said image block 27 includes an angle draft in the range of approximately 0.5% to 10%, in difference between the upper and lower walls of the that impressing or embossing portion.

105. The device for impressing and embossing images upon food products as in claim 103 wherein: an impressing and embossing portion of each said image block includes an angle draft in the range of approximately 2% to 4%, in difference between the upper and lower walls of the that impressing or embossing portion.

106. The device for impressing and embossing images upon food products as in claim 104 wherein said image blocks are doubled sided, having the same letter in both sides, the same letter in upper and lower case, having frequently used letters and additional vowels on one side to easily customize any word or message, and/or the same letter, number or image having impressing forms on one side and raised/embossing forms on the opposite side.

107. The device for impressing and embossing images upon food products as in claim 106 wherein each said image block includes a slot, latch extensions, a flat food contact surface, said latches engageable with said rim of said decorating wheel.

108. The device for impressing and embossing images upon food products as in claim 107 wherein each said image blocks includes at least one of optional side decoration impressions or raising/embossing, a letter impression, and a letter carved out below said food contact surface to form a raised or embossed form on an opposite surface.

109. The device for impressing and embossing images upon food products as in claim 108 wherein each said image block, includes a form of a particular letter pushed into the food surface, leaving an impression of said letter in the food surface.

110. The device for impressing and embossing images upon food products as in claim 109 wherein each said form of said letter on said image block is raised above said food contact surface of said decorating wheel, impressing a letter form of a predetermined depth allowing said letter to be legible, wherein further said decorating wheel is pushed along said food work surface to allow each said image block to come in contact with said food surface and form and spell a desired message and/or image, and said message and/or image being repeated as desired.

111. The device for impressing and embossing images upon food products as in claim 109 wherein to form raised letters or images, said image block includes a form of a letter, word and/or image carved into an initially, substantially flat food contact surface of said image block below said surface of said image block; said image block being carved to a depth sufficient to force the food stuff of the food work surface up into said carved out form of said letter and/or image during rotational application of said decorating wheel to said food work surface; said image block being carved out to a predetermined depth allowing sufficient food product to be forced upward into a raised pattern and substantially hold that pattern after cooking or baking.

112. The device for impressing and embossing images upon food products as in claim 111 wherein said food contact surface of said image block forming raised images includes an uncut portion surrounding said carved out portion; said uncut portion of said image block food contact surface forms edge borders around said carved out portion provides contact force to said food surface, each said edge border being formed in a width approximately in the range of as wide as said carved out portion, in toto, to as wide as said carved out portion of said block on each side of said carved out pattern said edge borders forcing the food product into said cutout and smoothing out an area surrounding said image, rendering said image to be a noticeable raised, relief pattern.

113. The device for impressing and embossing images upon food products as in claim 112 wherein: said respective edge borders of said food contact surface of said image block surrounding said carved out portion are ridged with respect to a predetermined depth of said carved out portion; said ridges spreading out the food surface evenly.

114. The device for impressing and embossing images upon food products as in claim 112 further comprising: said edge borders including a decorative pattern along an outer most portion of said edge border of said image block.

115. The device for impressing and embossing images upon food products as in claim 112 wherein said edge borders of said image block are curved upward.

116. The device for impressing and embossing images upon food products as in claim 112 wherein said edge borders of said image block are curved downward.

117. The device for impressing and embossing images upon food products as in claim 112 wherein each said latch extension of image block includes nibs on the distal ends of each said latch extension; said nibs snapping an edge of said rim at the top and through an edge of said hole at the bottom respectively, whereby: said image blocks attach to said rim of said decorating wheel.

118. The device for impressing and embossing images upon food products as in claim 101 wherein said elastomeric band is a flexible message strip having an attachment end-hole allowing said flexible message strip to be attached to said decorating wheel.

119. The device for impressing and embossing images upon food products as in claim 100 wherein a message strip includes a preformed message for at least one of impressing words down into the surface of the food product or forming raised/embossed words above the contact surface of the food product.

120. The device for impressing and embossing images upon food products as in claim 119 wherein said message strip includes nibs located on a lower surface of said flexible messages strip; said nibs being spaced so as to fit said holes on said rim of said decorating wheel; and a spring clip retaining said flexible message strip through said holes; said flexible message strip being removable and interchangeable with other respective message strips.

121. The device for impressing and embossing images upon food products as in claim 119 wherein said nibs of said flexible message strip are retained in respective holes of a flat stamper pad.

122. The device for impressing and embossing images upon food products as in claim 100 wherein said decorating wheel includes transverse ribs having undercut channels; said undercut channels allowing said image blocks to slide therebetween via at least one block flange.

123. The device for impressing and embossing images upon food products as in claim 122 wherein said at least one block flange is a pair of flanges.

124. The device for impressing and embossing images upon food products as in claim 100 wherein a flexible, elastomeric band having transverse ribs is a continuous band and said elastomeric band is placed over said rim of said decorating wheel by stretching.

125. The device for impressing and embossing images upon food products as in claim 124 wherein said elastomeric band is made of a food tolerant material selected from the group consisting essentially of plastics, silicone, rubbers, elastomers and combinations thereof.

126. The device for impressing and embossing images upon food products as in claim 125 further comprising a third, narrow wheel being cantilevered away from said housing and used on an impressed/embossed message to add further coloring substances, said cantilevered third wheel being adjustable in height via an adjuster to color enhance the raised portions of said embossed images.

127. The device for impressing and embossing images upon food products as in claim 126 wherein outer image color stripes are deposited by a pair of narrow dual wheels.

128. The device for impressing and embossing images upon food products as in claim 127 wherein each said coloring wheel includes a dispenser dispensing a multi-color image.

129. The device for impressing and embossing images upon food products comprising a stamper pad enclosed within a vertically movable housing, said vertically movable housing having a handle extending therefrom; a depth adjuster knob, and a base ring covering and protecting a lower portion of said housing, wherein by temporarily removing said base ring, an exposed lower portion of said housing frames and cuts through a food work surface around an impressed and/or embossed image.

130. The device for impressing and embossing images upon food products as in claim 129 wherein said stamper pad includes a message plate, said message plate accepting removeably attaching an at least one of an image and block a message strips or a pre-formed message on an interchangeable message plate; said stamper pad having an engaging column, a spring, a housing, a handle and said depth adjuster knob; said message plate being pressed into contact with the food contact surface to form said image.

131. A device for impressing food surfaces having interchangeable images comprising: a housing and a carrier for removable image-producing media, said carrier being removeably attached to the housing.

132. The device as in claim 131 wherein said media include at least one of image-producing blocks, message bands and/or message strips that are removeably attached to the carrier.

133. A device for embossing food surfaces having interchangeable images comprising: a housing, and a carrier for removable image-producing media, said carrier being removeably attached to the housing.

134. The device as in claim 134 wherein said media include at least one of image-producing blocks, message bands and/or message strips that are removeably attached to the carrier.

135. A device for impressing and embossing food surfaces having interchangeable images comprising: a housing, and a carrier for removable image-producing media, said carrier being removeably attached to the housing.

136. The device as in claim 135 wherein said media include at least one of image-producing blocks, message bands and/or message strips that are removeably attached to the carrier.
